(19) United States
(12) Patent Application Publication
(10) Pub. No.: US 2025/0096298 A1
(43) Pub. Date: Mar. 20, 2025

(54) FUEL CELL STACK

(71) Applicant: TOYOTA BOSHOKU KABUSHIKI KAISHA, Aichi-ken (JP)

(72) Inventors: Haruyuki AONO, Aichi-ken (JP); Satoshi KAWABE, Ichinomiya-shi (JP); Harutaka ODA, Toyota-shi (JP)

(73) Assignee: TOYOTA BOSHOKU KABUSHIKI KAISHA, Aichi-ken (JP)

(21) Appl. No.: 18/883,277

(22) Filed: Sep. 12, 2024

(30) Foreign Application Priority Data
Sep. 20, 2023 (JP) 2023-152633

(51) Int. Cl. H01M 8/2483; H01M 8/04119

(52) U.S. Cl. CPC H01M 8/2483; H01M 8/04156

(57) ABSTRACT

A fuel cell stack includes power generation cells stacked in a first direction that is orthogonal to a vertical direction. The fuel cell stack includes a gas passage, a gas supply manifold, and a gas discharge manifold. The gas supply manifold and the gas discharge manifold are each located at a position aligned with the gas passage in a second direction and extend through the power generation cells in the first direction. A lower portion of a peripheral edge of the gas discharge manifold includes a reservoir. In the reservoir, an area of a cross-section that is orthogonal to the first direction is partially reduced. The reservoir is located below, in the vertical direction, a lowermost part of a portion that connects the peripheral edge of the gas discharge manifold to the gas passage.

### CROSS-REFERENCE TO RELATED APPLICATIONS

This application is based upon and claims the benefit of priority from prior Japanese Patent Application No. 2023-152633, filed on Sep. 20, 2023, the entire contents of which are incorporated herein by reference.

### BACKGROUND

### 1. Field

The present disclosure relates to a fuel cell stack.

### 2. Description of Related Art

Japanese Laid-Open Patent Publication No. 2018-78020 discloses a fuel cell stack including stacked cells. Each cell includes a membrane electrode assembly that generates power when supplied with reactant gases. The fuel cell stack includes a fuel gas supply manifold that supplies fuel gas to the cells as a reactant gas and a fuel gas discharge manifold that discharges the fuel gas used to generate power. Additionally, the fuel stack includes an oxidant gas supply manifold that supplies oxidant gas to the cells as a reactant gas and an oxidant gas discharge manifold that discharges the oxidant gas used to generate power. Power is generated through the electrochemical reaction between the fuel gas and the oxidant gas in the membrane electrode assembly of each cell.

Fuel gas and oxidant gas may be supplied to the cells in a humidified state. Thus, condensed water from the moisture contained in the fuel gas may accumulate in the fuel gas supply manifold and the fuel gas discharge manifold. Further, in addition to condensed water, the water produced during power generation may accumulate in the oxidant gas supply manifold and the oxidant gas discharge manifold. When water accumulates in each manifold, the cross-sectional flow area of the manifold decreases. This may hinder the smooth flow of reactant gases, resulting in a decrease in the power generation performance of the fuel cell stack.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fuel cell stack according to an aspect of the present disclosure includes power generation cells stacked in a first direction that intersects a vertical direction. Each of the power generation cells includes a power generation portion generating power when supplied with reactant gas. The fuel cell stack further includes a gas passage which faces the power generation portion and through which the reactant gas flows. The fuel cell stack further includes a gas supply manifold and a gas discharge manifold that are connected to the gas passage. The gas supply manifold and the gas discharge manifold are each located at a position aligned with the gas passage in a second direction and extend through the power generation cells in the first direction. The second direction is orthogonal to the vertical direction and the first direction. A lower portion of a peripheral edge of the gas discharge manifold includes a reservoir in which an area of a cross-section that is orthogonal to the first direction is partially reduced. The reservoir is configured to store moisture contained in the reactant gas. The reservoir is located below, in the vertical direction, a lowermost part of a portion that connects the peripheral edge of the gas discharge manifold to the gas passage.

Other features and aspects will be apparent from the following detailed description, the drawings, and the claims.

### BRIEF DESCRIPTION OF THE DRAWINGS

FIG. 1 is a front view illustrating a mobile unit on which a fuel cell including a fuel cell stack according to an embodiment is mounted.

FIG. 2 is a perspective view of the fuel cell shown in FIG. 1.

FIG. 3 is a cross-sectional view of the fuel cell shown in FIG. 1.

FIG. 4 is a front view of the fuel gas passage of the separator included in the power generation cell shown in FIG. 1.

FIG. 5 is a front view of the oxidant gas passage of the separator included in the power generation cell shown in FIG. 1.

FIG. 6 is a front view of the fuel gas passage of the separator included in the dummy cell shown in FIG. 1.

FIG. 7 is an enlarged view of the fuel gas discharge manifold shown in FIG. 4.

FIG. 8 is a front view of the fuel gas discharge manifold when the mobile unit shown in FIG. 1 is inclined.

FIG. 9 is a front view of the fuel gas discharge manifold according to a first modification.

FIG. 10 is a front view of the fuel gas discharge manifold according to a second modification.

FIG. 11 is a front view of the fuel gas discharge manifold according to a third modification.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

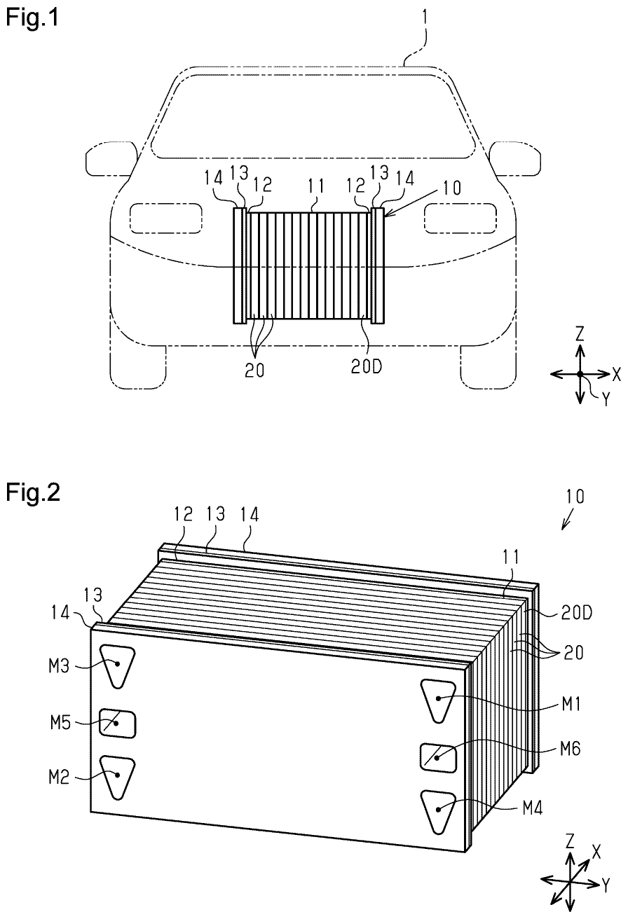

A fuel cell stack according to an embodiment will now be described with reference to FIGS. 1 to 8.

### Fuel Cell 10

As shown in FIG. 1, the fuel cell 10 is mounted on a mobile unit 1, such as an automobile. The fuel cell 10 supplies power to a motor (not shown) that drives the mobile unit 1.

The fuel cell 10 includes a fuel cell stack 11, two terminal plates 12, two insulating plates 13, and two end plates 14.

### Fuel Cell Stack 11

The fuel cell stack 11 is formed by stacking power generation cells 20 that generate power and a dummy cell 20D that does not generate power. The power generation cells 20 are stacked in a direction that intersects the vertical direction. The dummy cell 20D is located at one end of the power generation cells 20 in the stacking direction.

Hereinafter, the stacking direction of the fuel cell stack 11 may be referred to as the X-axis direction, the vertical direction may be referred to as the Z-axis direction, and the direction that is orthogonal to the X-axis direction and Z-axis direction may be referred to as the Y-axis direction. Further, the upper side and the lower side in the Z-axis direction may be simply referred to as the upper side and the lower side, respectively.

The X-axis direction is, for example, a horizontal direction that is orthogonal to the vertical direction. The X-axis direction coincides with the width direction of the mobile unit 1, which is orthogonal to the direction in which the mobile unit 1 moves. Thus, the Y-axis direction coincides with the movement direction of the mobile unit 1. The X-axis direction is an example of a first direction. The Y-axis direction is an example of a second direction. The terminal plate 12, insulating plate 13, and end plate 14 are sequentially

arranged from the fuel cell stack 11 at each of one end and the other end of the fuel cell stack 11 in the X-axis direction. The terminal plate 12 collects power from the power generation cells 20. The insulating plate 13 insulates between the terminal plate 12 and the end plate 14. The end plate 14 applies a clamping load to the fuel cell stack 11.

As shown in FIG. 2, the fuel cell stack 11 includes a fuel gas supply manifold M1, a fuel gas discharge manifold M2, an oxidant gas supply manifold M3, an oxidant gas discharge manifold M4, a cooling medium supply manifold M5, and a cooling medium discharge manifold M6. The fuel gas supply manifold M1 is located above the fuel gas discharge manifold M2. The oxidant gas supply manifold M3 is located above the oxidant gas discharge manifold M4.

The fuel gas supply manifold M1, fuel gas discharge manifold M2, oxidant gas supply manifold M3, and oxidant gas discharge manifold M4, as viewed from the front, have the shape of, for example, a rounded isosceles triangle with the base at the top. The cooling medium supply manifold M5 and cooling medium discharge manifold M6, as viewed from the front, have the shape of, for example, a rounded rectangle.

The fuel gas supply manifold M1 supplies fuel gas as a reactant gas to the interior of the fuel cell stack 11. The fuel gas discharge manifold M2 discharges fuel gas to the exterior of the fuel cell stack 11. The oxidant gas supply manifold M3 supplies oxidant gas as a reactant gas to the interior of the fuel cell stack 11. The oxidant gas discharge manifold M4 discharges oxidant gas to the exterior of the fuel cell stack 11. The cooling medium supply manifold M5 supplies a cooling medium to the interior of the fuel cell stack 11. The cooling medium discharge manifold M6 discharges a cooling medium to the exterior of the fuel cell stack 11. The fuel gas is, for example, hydrogen. The oxidant gas is, for example, air. The cooling medium is, for example, water.

The manifolds M1 to M6 extend through all the power generation cells 20 and the dummy cell 20D in the X-axis direction. The manifolds M1 to M6 extend through the terminal plate 12, the insulating plate 13, and the end plate 14 that are arranged on one side of the fuel cell stack 11 in the X-axis direction. The manifolds M1 to M6 do not extend through the terminal plate 12, the insulating plate 13, and the end plate 14 that are arranged on the other side of the fuel cell stack 11 in the X-axis direction. Thus, the manifolds M1 to M6 are open only on one side of the fuel cell stack 11 in the X-axis direction.

The fuel gas supplied from the fuel gas supply manifold M1 flows through the power generation cells 20 and the dummy cell 20D and is then discharged outside the fuel cell stack 11 through the fuel gas discharge manifold M2. The oxidant gas supplied from the oxidant gas supply manifold M3 flows through the power generation cells 20 and the dummy cell 20D and is then discharged outside the fuel cell stack 11 through the oxidant gas discharge manifold M4. The cooling medium supplied from the cooling medium supply manifold M5 flows through the power generation cells 20 and the dummy cell 20D and is then discharged outside the fuel cell stack 11 through the cooling medium discharge manifold M6.

The fuel gas supply manifold M1, the cooling medium discharge manifold M6, and the oxidant gas discharge manifold M4 are arranged in this order from top to bottom at one end of the fuel cell stack 11 in the Y-axis direction. The oxidant gas supply manifold M3, the cooling medium supply manifold M5, and the fuel gas discharge manifold M2 are arranged in this order from top to bottom at the other end of the fuel cell stack 11 in the Y-axis direction.

### Power Generation Cell 20

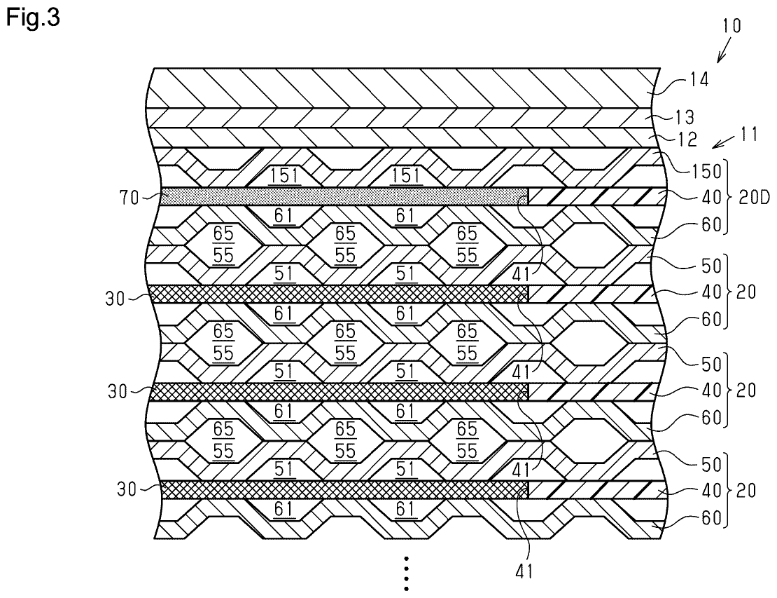

As shown in FIG. 3, each power generation cell 20 includes a power generation portion 30, a frame 40, and two separators 50, 60. The power generation portion 30 has the shape of a sheet. The frame 40 surrounds the outer edge of the power generation portion 30. The power generation portion 30 and the frame 40 are held between the two separators 50, 60.

The frame 40 and the two separators 50, 60 each have a through-hole defined by the manifolds M1 to M6.

The power generation portion 30 includes a membrane electrode assembly, an anode-side gas diffusion layer, and a cathode-side gas diffusion layer. The membrane electrode assembly is held between the anode-side gas diffusion layer and the cathode-side gas diffusion layer. The membrane electrode assembly includes an electrolyte membrane, an anode catalyst layer, and a cathode catalyst layer. The electrolyte membrane is held between the anode catalyst layer and the cathode catalyst.

The frame 40 is made of insulating plastic. The frame 40 includes an accommodating hole 41 at its central portion to accommodate the power generation portion 30.

The separators 50, 60 are formed by pressing a metal (e.g., stainless steel or titanium alloy) plate.

The separator 50 is located on an anode-side surface of the power generation portion 30. The separator 60 is located on a cathode-side surface of the power generation portion 30.

The surface of the separator 50 facing the anode-side surface of the power generation portion 30 includes a fuel gas passage 51 through which fuel gas flows. The surface of the separator 60 facing the cathode-side surface of the power generation portion 30 includes an oxidant gas passage 61 through which oxidant gas flows. The fuel gas passage 51 and the oxidant gas passage 61 are defined by grooves arranged next to each other.

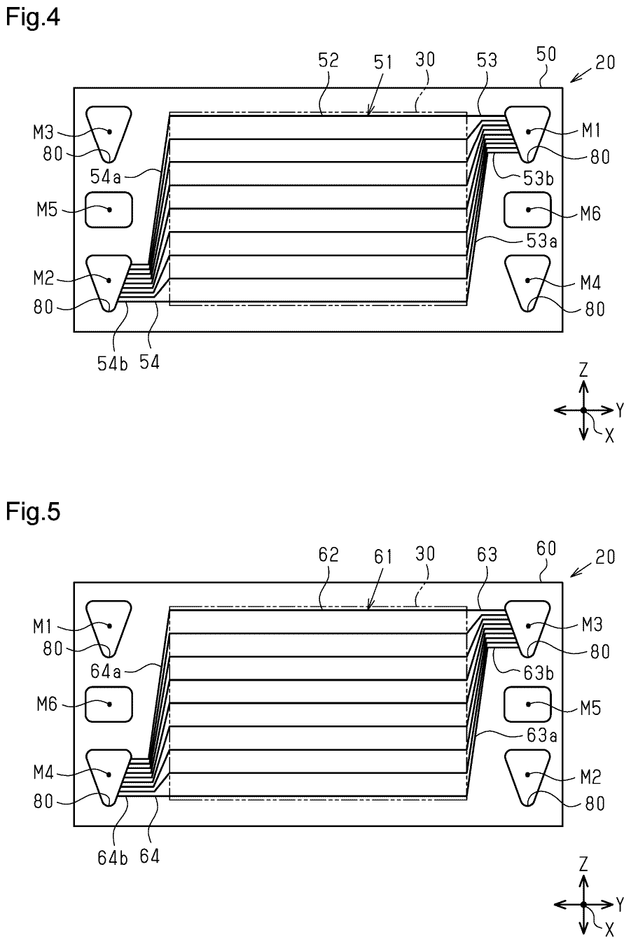

As shown in FIG. 4, the fuel gas passage 51 is located at a position aligned with the fuel gas supply manifold M1 and the fuel gas discharge manifold M2 in the Y-axis direction.

The fuel gas passage 51 includes a main passage 52, a supply-side connecting passage 53, and a discharge-side connecting passage 54.

The main passage 52 faces the power generation portion 30 and extends in the Y-axis direction.

The supply-side connecting passage 53 connects the main passage 52 to the fuel gas supply manifold M1. The supply-side connecting passage 53 includes inclined sections 53a and straight sections 53b. The inclined sections 53a extend from the main passage 52 and are inclined with respect to the Y-axis direction and the Z-axis direction. The straight sections 53b extend straight in the Y-axis direction from the main passage 52 or the inclined sections 53a and are connected to the fuel gas supply manifold M1.

The discharge-side connecting passage 54 connects the main passage 52 to the fuel gas discharge manifold M2. The discharge-side connecting passage 54 includes inclined sections 54a and straight sections 54b. The inclined sections 54a extend from the main passage 52 and are inclined with respect to the Y-axis direction and the Z-axis direction. The straight sections 54b extend straight in the Y-axis direction from the main passage 52 or the inclined sections 54a and are connected to the fuel gas discharge manifold M2.

As shown in FIG. 5, the oxidant gas passage 61 is located at a position aligned with the oxidant gas supply manifold M3 and the oxidant gas discharge manifold M4 in the Y-axis direction.

The oxidant gas passage 61 includes a main passage 62, a supply-side connecting passage 63, and a discharge-side connecting passage 64.

The main passage 62 faces the power generation portion 30 and extends in the Y-axis direction.

The supply-side connecting passage 63 connects the main passage 62 to the oxidant gas supply manifold M3. The supply-side connecting passage 63 includes inclined sections 63a and straight sections 63b. The inclined sections 63a extend from the main passage 62 and are inclined with respect to the Y-axis direction and the Z-axis direction. The straight sections 63b extend straight in the Y-axis direction from the main passage 62 or the inclined sections 63a and are connected to the oxidant gas supply manifold M3.

The discharge-side connecting passage 64 connects the main passage 62 to the oxidant gas discharge manifold M4. The discharge-side connecting passage 64 includes inclined sections 64a and straight sections 64b. The inclined sections 64a extends from the main passage 62 and are inclined with respect to the Y-axis direction and the Z-axis direction. The straight sections 64b extend straight in the Y-axis direction from the main passage 62 or the inclined section 64a and are connected to the oxidant gas discharge manifold M4.

As shown in FIG. 3, the back surface of the surface of the separator 50 in which the fuel gas passage 51 is formed includes a cooling passage 55 through which a cooling medium flows. The back surface of the surface of the separator 60 in which the oxidant gas passage 61 is formed includes a cooling passage 65 through which a cooling medium flows. The cooling passages 55, 65 are connected to the cooling medium supply manifold M5 and the cooling medium discharge manifold M6. The cooling medium flows through the space defined by the cooling passages 55, 65 of the separators 50, 60, which are in contact with each other in the X-axis direction.

### Dummy Cell 20D

The dummy cell 20D is stacked on the downstream side of the power generation cells 20 in the flow direction of fuel gas flowing through the fuel gas supply manifold M1.

The dummy cell 20D includes a conductive member 70, a frame 40, and two separators 150, 60. In the dummy cell 20D, the power generation portion 30 of each power generation cell 20 is replaced with the conductive member 70, which is shaped in conformance with the power generation portion 30. Thus, even if reactant gas flows into the dummy cell 20D, the dummy cell 20D does not generate power.

The frame 40 and the separator 60 of the dummy cell 20D have the same configurations as the frame 40 and the separator 60 of each power generation cell 20, respectively.

The separator 150 of the dummy cell 20D includes a fuel gas passage 151 that has a different shape from that of the separator 50 of the power generation cell 20. The difference between the fuel gas passage 151 of the dummy cell 20D and the fuel gas passage 51 of the power generation cell 20 is the number of the straight sections 53b in the supply-side connecting passage 53. The number of the straight sections 53b in the dummy cells 20D is greater than the number of the straight sections 53b in the power generation cell 20. The configuration of the fuel gas passage 151 is the same as that of the fuel gas passage 51, except for the number of the straight sections 53b. Thus, the components of the fuel gas passage 51 are given reference numbers, and therefore the fuel gas passage 151 will not be described in detail.

### Reservoir 80

As shown in FIGS. 4 to 6, a lower portion of a peripheral edge of the fuel gas supply manifold M1 includes a reservoir 80. In the reservoir 80, the area of the cross-section that is orthogonal to the X-axis direction (hereinafter referred to as the cross-sectional area) is partially reduced. The reservoir 80 stores the moisture contained in reactant gas. The reservoir 80 extends over the entire fuel gas supply manifold M1 in the X-axis direction.

Similarly, a lower portion of a peripheral edge of each of the fuel gas discharge manifold M2, the oxidant gas supply manifold M3, and the oxidant gas discharge manifold M4 includes the reservoir 80. The reservoirs 80 of the manifolds M1 to M4 have the same configuration.

The reservoir 80 of the fuel gas supply manifold M1 and the reservoir 80 of the fuel gas discharge manifold M2 will now be described in detail. Hereinafter, the reservoir 80 of the fuel gas supply manifold M1 can be read as the reservoir 80 of the oxidant gas supply manifold M3, and the reservoir 80 of the fuel gas discharge manifold M2 can be read as the reservoir 80 of the oxidant gas discharge manifold M4.

As shown in FIG. 4, the portion of the reservoir 80 of the fuel gas supply manifold M1 that is included in the power generation cell 20 is located below a lowermost part of the portion that connects the peripheral edge of the fuel gas supply manifold M1 to the fuel gas passage 51. Specifically, the reservoir 80 in the power generation cell 20 is located below the lowermost one of the straight sections 53b of the supply-side connecting passage 53. In other words, the straight sections 53b of the supply-side connecting passage 53 are connected to the fuel gas supply manifold M1 at positions of the peripheral edge of the fuel gas supply manifold M1 above the reservoir 80.

The portion of the reservoir 80 of the fuel gas discharge manifold M2 that is included in the power generation cell 20 is located below a lowermost part of the portion that connects the peripheral edge of the fuel gas discharge manifold M2 to the fuel gas passage 51. Specifically, the reservoir 80 in the power generation cell 20 is located below the lowermost one of the straight sections 54b of the discharge-side connecting passage 54. In other words, the straight sections 54b of the discharge-side connecting passage 54 are connected to the fuel gas discharge manifold M2 at positions of the peripheral edge of the fuel gas discharge manifold M2 above the reservoir 80.

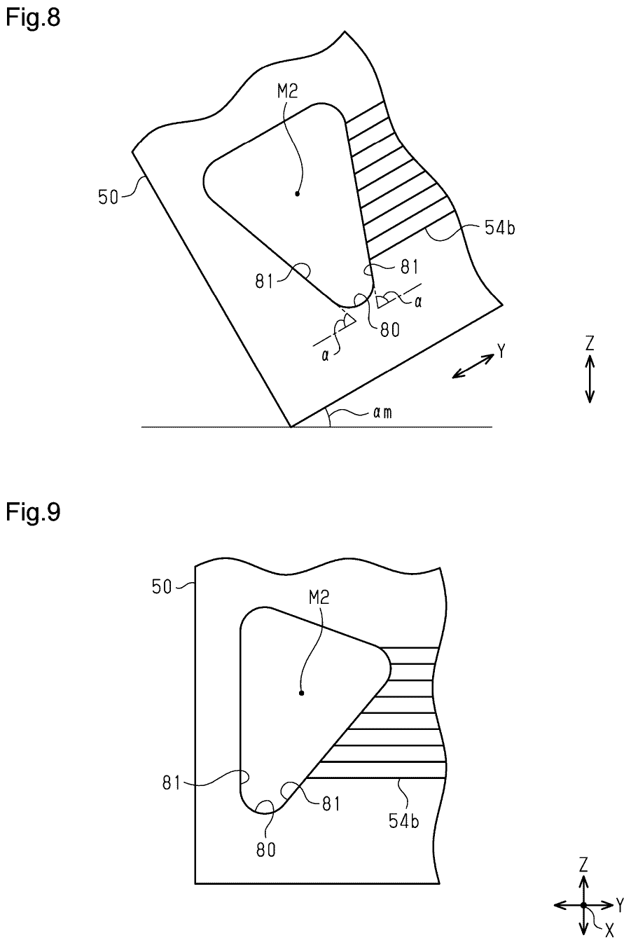

As shown in FIG. 7, the reservoir 80 includes two side walls 81 that face each other in the Y-axis direction. The two side walls 81 are inclined with respect to the Z-axis direction such that they become closer to each other toward the lower section. Inclination angles α of the two side walls 81 with respect to the Y-axis direction are equal to each other. As shown in FIG. 8, the mobile unit 1 (see FIG. 1) may be inclined with respect to the horizontal direction while moving on, for example, a slope. The inclination angle α of each of the two side walls 81 in the Y-axis direction is set to be greater than a maximum inclination angle αm. The maximum inclination angle αm is a maximum value of the inclination angle of the mobile unit 1 with respect to the horizontal direction assumed during the movement of the mobile unit 1. The maximum inclination angle αm is, for example, between 15° and 30°.

Corners of the peripheral edges of the manifolds M1 to M6, which include the lower ends of the two side walls 81, have arcuate cross-sections that are orthogonal to the X-axis direction. By providing such an arcuate portion, the punching of the separators 50, 60, 150 to form the through-holes that are included in each of the manifolds M1 to M6 becomes easier compared to when the corners have a sharp angular shape.

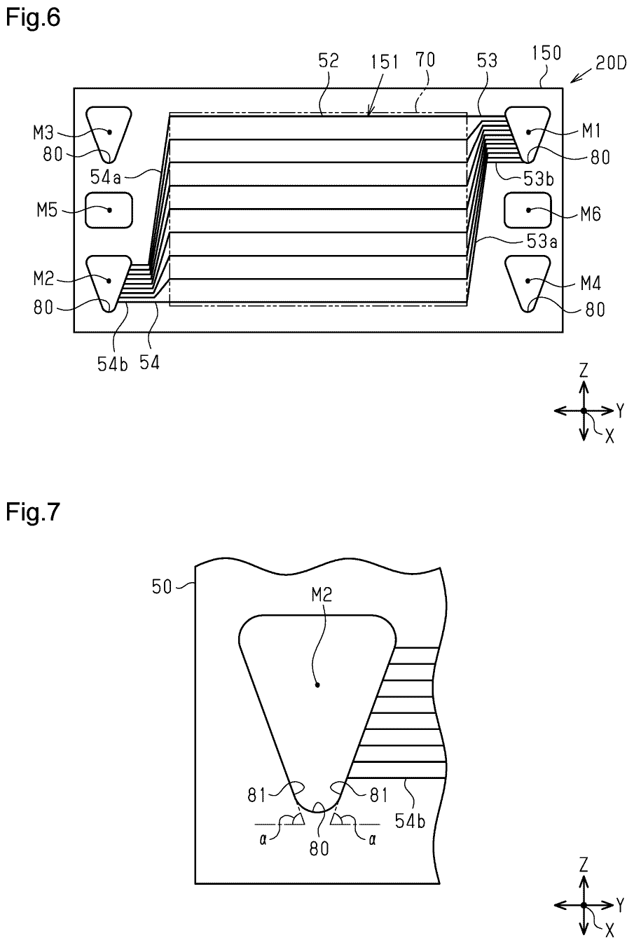

As shown in FIG. 6, the portion of the reservoir 80 of the fuel gas supply manifold M1 that is included in the dummy cell 20D is connected to the fuel gas passage 151 of the dummy cell 20D. Specifically, the portion of the reservoir 80 of the fuel gas supply manifold M1 that is included in the dummy cell 20D is connected to one or more straight sections 53b in the supply-side connecting passage 53 of the dummy cell 20D. The straight sections 53b, for example, extend by branching off from a single inclined section 53a and open in the reservoir 80. The straight sections 53b are located below the supply-side connecting passage 53 of the power generation cell 20. The portion of the reservoir 80 of the fuel gas discharge manifold M2 that is included in the dummy cell 20D is not connected to the fuel gas passage 151 of the dummy cell 20D. Although not illustrated in the drawings, the portions of the reservoirs 80 of the oxidant gas supply manifold M3 and the oxidant gas discharge manifold M4 that are included in the dummy cell 20D are not connected to the oxidant gas passage of the dummy cell 20D.

The operation of the present embodiment will now be described.

The reservoir 80 of the fuel gas discharge manifold M2 is located below the lowermost part of the portion that connects the peripheral edge of the fuel gas discharge manifold M2 to the fuel gas passage 51. This allows the water that has flowed into the fuel gas discharge manifold M2 to be easily stored in the reservoir 80. Further, the cross-sectional area of the reservoir 80 is partially reduced. Thus, the flow speed of reactant gas flowing through the reservoir 80 is greater than the flow speed in other sections of the fuel gas discharge manifold M2. The same applies to the oxidant gas discharge manifold M4.

The advantages of the present embodiment will now be described.
(1) The lower portion of the peripheral edge of each of the fuel gas discharge manifold M2 and the oxidant gas discharge manifold M4 includes the reservoir 80, which has a cross-sectional area that is partially reduced and stores the moisture contained in reactant gas. The reservoir 80 of the fuel gas discharge manifold M2 is located below the lowermost part of the portion that connects the peripheral edge of the fuel gas discharge manifold M2 to the fuel gas passage 51. The reservoir 80 of the oxidant gas discharge manifold M4 is located below the lowermost part of the portion that connects the peripheral edge of the oxidant gas discharge manifold M4 to the oxidant gas passage 61.

This configuration produces the above-described operation. This allows the water that has flowed into fuel gas discharge manifold M2 and stored in the reservoir 80 to easily flow through the fuel gas discharge manifold M2 together with reactant gas. This limits a decrease in the cross-sectional flow area of the fuel gas discharge manifold M2 caused by water accumulation. The same applies to the oxidant gas discharge manifold M4.
(2) The lower portion of the peripheral edge of each of the fuel gas supply manifold M1 and the oxidant gas supply manifold M3 includes the reservoir 80. The reservoir 80 of the fuel gas supply manifold M1 is located below the portion that connects the peripheral edge of the fuel gas supply manifold M1 to the fuel gas passage 51. The reservoir 80 of the oxidant gas supply manifold M3 is located below the portion that connects the peripheral edge of the oxidant gas supply manifold M3 to the oxidant gas passage 61.

This configuration allows the water that has flowed into the fuel gas supply manifold M1 to be easily stored in the reservoir 80. Further, the flow speed of reactant gas flowing through the reservoir 80 is greater than the flow speed in other sections of the fuel gas supply manifold M1. This allows the water that has flowed into fuel gas supply manifold M1 and stored in the reservoir 80 to easily flow through the fuel gas supply manifold M1 together with reactant gas. This limits a decrease in the cross-sectional flow area of the fuel gas supply manifold M1 caused by water accumulation. The same applies to the oxidant gas supply manifold M3.
(3) The portion of the reservoir 80 of the fuel gas supply manifold M1 that is included in the dummy cell 20D is connected to the fuel gas passage 151 of the dummy cell 20D.

In this configuration, when water accumulates in the reservoir 80 of the fuel gas supply manifold M1, the water flows from the portion of the reservoir 80 that is included in the dummy cell 20D toward the fuel gas passage 151 of the dummy cell 20D. The water is then discharged from the fuel gas discharge manifold M2 to the outside. This limits the flow of water into the fuel gas passage 51 of the power generation cell 20, which generates power, while facilitating the flow of water into the fuel gas passage 151 of the dummy cell 20D, which does not generate power. Accordingly, a decrease in the power generating performance of the fuel cell stack 11 is limited.
(4) The cross-sectional area of the reservoir 80 gradually decreases toward the lower section.

In this configuration, the flow speed of reactant gas flowing through the reservoir 80 increases toward the lower section. Thus, the smaller the amount of water stored in the reservoir 80, the greater the flow speed of the reactant gas flowing through the reservoir 80. This facilitates quick flow of the water stored in the reservoir 80 through each of the manifolds M1 to M4 together with reactant gas. Accordingly, the drainage performance of each of the manifolds M1 to M4 is enhanced.
(5) The two side walls 81 of the reservoir 80 are inclined with respect to the Z-axis direction such that they become closer to each other toward the lower section.

This configuration allows the water adhering to the side walls 81 of the reservoir 80 to easily flow downward along the side walls 81. The flow speed of reactant gas in the reservoir 80 increases as it flows downward. This allows the water that has flowed downward along the side walls 81 to easily flow through the manifolds M1 to M4 together with reactant gas. Accordingly, the drainage performance of each of the manifolds M1 to M4 is further enhanced.
(6) The inclination angle α of each of the two side walls 81 of the reservoir 80 with respect to the horizontal direction is greater than the maximum inclination angle αm.

In this configuration, even if the fuel cell stack 11 is inclined with respect to the horizontal direction due to a change in the orientation of the fuel cell stack 11 as the mobile unit 1 moves as shown in FIG. 8, the orientation in which the side walls 81 are sloped toward the reservoir 80 is maintained. This prevents the water stored in the reservoir 80 from flowing into the fuel gas passage 51 or the oxidant gas passage 61.

### Modifications

The present embodiment may be modified as follows. The present embodiment and the following modifications can be combined as long as they remain technically consistent with each other.

The inclination angles α of the two side walls 81 of the reservoir 80 may differ from each other.

The inclination angle α of at least one of the two side walls 81 of the reservoir 80 may be less than the maximum inclination angle αm.

The fuel cell stack 11 does not have to be mounted on the mobile unit 1. The fuel cell stack 11 may be employed in, for example, a stationary fuel cell stack 11.

As shown in FIG. 9, one of the two side walls 81 of the reservoir 80 may extend in the Z-axis direction.

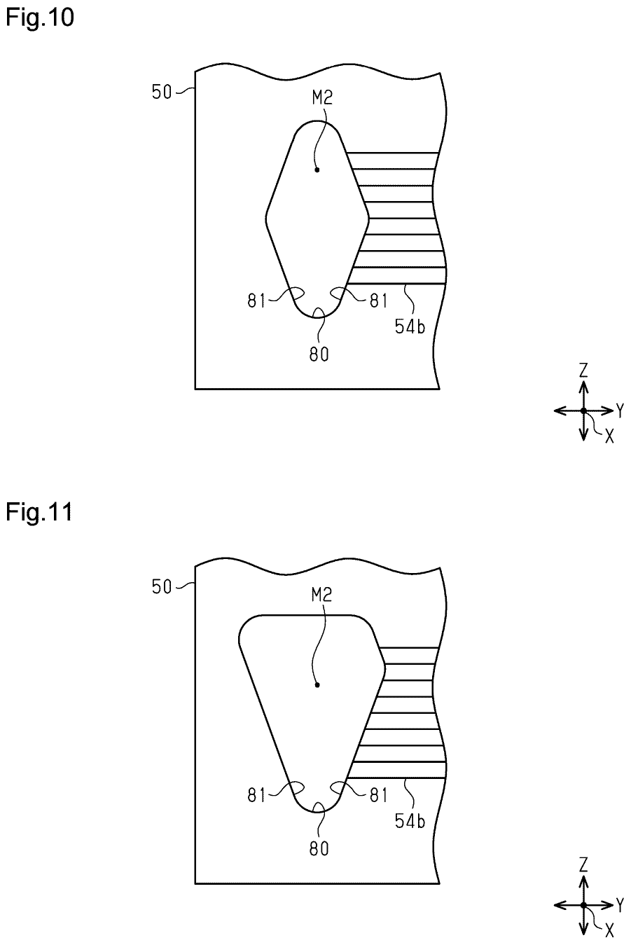

The sections of each of the manifolds M1 to M4 excluding the reservoir 80 may have any shape. For example, as shown in FIG. 10, the upper portion of the fuel gas discharge manifold M2 may have a cross-sectional area that decreases toward the upper section. Alternatively, as shown in FIG. 11, the fuel gas discharge manifold M2 may have an asymmetrical shape with respect to the Y-axis direction.

The cross-sectional area of the reservoir 80 may gradually decrease in a stepwise manner toward the lower section. In this case, the distance between the two side walls 81 in the Y-axis direction needs to decrease in a stepwise manner.

The reservoir 80 may be a groove provided on the bottom surface of the fuel gas discharge manifold M2. In this case, the cross-sectional area of the reservoir 80 may remain constant in the Z-axis direction if it may be smaller than the cross-sectional areas in other sections.

The fuel gas passage 151 of the dummy cell 20D may be connected to the bottom surface of the portion of the reservoir 80 included in the dummy cell 20D.

The portion of the reservoir 80 of the fuel gas discharge manifold M2 that is included in the dummy cell 20D may be connected to the fuel gas passage 151 of the dummy cell 20D.

The portion of the reservoir 80 of at least one of the oxidant gas supply manifold M3 and the oxidant gas discharge manifold M4 that is included in the dummy cell 20D may be connected to the oxidant gas passage (not shown) of the dummy cell 20D.

The dummy cell 20D may be located between multiple power generation cells 20. That is, the dummy cell 20D may be held between the power generation cells 20.

The dummy cell 20D may be located at each of the opposite ends of the power generation cells 20 in the X-axis direction.

The fuel cell stack 11 does not have to include the dummy cell 20D.

At least one of the fuel gas supply manifold M1 and the oxidant gas supply manifold M3 does not have to include the reservoir 80.

The reservoir 80 may be included in only one of the fuel gas discharge manifold M2 and the oxidant gas discharge manifold M4.

At least part of each of the supply-side connecting passages 53, 63 and the discharge-side connecting passages 54, 64 may be a connection hole that extends through the frame 40 and is connected to any one of the manifolds M1 to M4.

The X-axis direction, which is the stacking direction of the power generation cells 20, may be inclined with respect to the vertical and horizontal directions.

The above-described modifications for the fuel gas discharge manifold M2 may also be employed in the manifolds M1, M3, M4.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising power generation cells stacked in a first direction that intersects a vertical direction, each of the power generation cells including a power generation portion generating power when supplied with reactant gas, the fuel cell stack further comprising:
a gas passage which faces the power generation portion and through which the reactant gas flows; and
a gas supply manifold and a gas discharge manifold that are connected to the gas passage, wherein
the gas supply manifold and the gas discharge manifold are each located at a position aligned with the gas passage in a second direction and extend through the power generation cells in the first direction, the second direction being orthogonal to the vertical direction and the first direction,
a lower portion of a peripheral edge of the gas discharge manifold includes a reservoir in which an area of a cross-section that is orthogonal to the first direction is partially reduced, the reservoir being configured to store moisture contained in the reactant gas, and
the reservoir is located below, in the vertical direction, a lowermost part of a portion that connects the peripheral edge of the gas discharge manifold to the gas passage.

2. The fuel cell stack according to claim 1, wherein
a lower portion of a peripheral edge of the gas supply manifold includes a reservoir in which an area of a cross-section that is orthogonal to the first direction is partially reduced, the reservoir being configured to store moisture contained in the reactant gas, and
the reservoir of the gas supply manifold is located below, in the vertical direction, a portion that connects the peripheral edge of the gas supply manifold to the gas passage.

3. The fuel cell stack according to claim 2, wherein
a flow direction of the reactant gas flowing through the gas supply manifold is simply referred to as a flow direction,
the fuel cell stack further comprises a dummy cell stacked on a downstream side of the power generation cells in the flow direction, wherein the dummy cell does not generate power,
the dummy cell includes a gas passage through which the reactant gas flows,
the gas supply manifold and the gas discharge manifold extend through the dummy cell and are connected to the gas passage of the dummy cell, and
a portion of the reservoir of the gas supply manifold that is included in the dummy cell is connected to the gas passage of the dummy cell.

4. The fuel cell stack according to claim 1, wherein
the area of the reservoir gradually decreases toward a lower section in the vertical direction.

5. The fuel cell stack according to claim 4, wherein
the reservoir includes two side walls that face each other in the second direction, and
the two side walls are inclined with respect to the vertical direction such that the two side walls become closer to each other toward the lower section in the vertical direction.

6. The fuel cell stack according to claim 5, wherein
the fuel cell stack is mounted on a mobile unit in an orientation in which the second direction coincides with a movement direction of the mobile unit,
a maximum value of an inclination angle of the mobile unit with respect to a horizontal direction assumed during movement of the mobile unit is referred to as a maximum inclination angle, and
an inclination angle of each of the two side walls with respect to the second direction is greater than the maximum inclination angle.
